(19) United States
(12) Patent Application Publication
(10) Pub. No.: US 2014/0137450 A1
(43) Pub. Date: May 22, 2014

(54) Viewties

(71) Applicant: Judith Kathleen Knez, Bokeelia, FL (US)

(72) Inventor: Judith Kathleen Knez, Bokeelia, FL (US)

(21) Appl. No.: 13/680,019

(22) Filed: Nov. 17, 2012

(51) Int. Cl. G09F 7/18

(52) U.S. Cl. CPC G09F 7/18
USPC 40/600

(57) ABSTRACT

Outdoor screened areas such as around swimming pools and porches tend to be somewhat drab and dull. Colored screening material is available with permanently-imprinted designs, but once installed, the same scene can become monotonous day after day, and cannot be replaced without removing the entire screen which is costly. Viewtees are two-piece identical foam or plastic decorative ornaments that magnetically attach together on opposing sides of outdoor screens, displaying colorful graphics from both the inside and outside views. Viewtees designs are virtually unlimited, with themes encompassing animals, nature and holidays, to name a few. They may vary in size to cover from one to ten square foot areas, where the larger versions also offer a degree of privacy and shade. Viewtees are easy to install and remove as they just magnetically snap together. Once removed, they may be replaced by another ornament and reused at a later date.

Viewties are decorative two-piece foam or plastic shaped designs, magnetically attached together, to form a colorful display on both sides of an outdoor screen. Unlike screens that have permanently-imprinted designs directly on the screen material, this invention offers versatility since any Viewties design may be easily removed, replaced, and reused as desired. Viewties range in size to cover areas between one to ten feet square. Larger sized Viewties may provide some degree of privacy, and shielding from sun and/or wind. Viewties are easy to install by putting the front piece and the back piece together with the screen “sandwiched” between the two pieces. They are held in place by mutually aligned magnets located on the inside surfaces of both pieces. A wide variety of designs may be displayed including, but not limited to holiday, animal and nature themes. This invention is particularly appropriate for screened-in swimming pool areas, as well as for other screened areas such as screened doors and windows, lanais and porches. Optimally, Viewties are made using industry-standard foam or plastic mold production techniques, but may also be handmade using hotwire foam-cutting tools. Viewties may be single or multi-dimensional.

### DESCRIPTION OF DRAWINGS

[NOTE: Drawings are not to scale]

FIG. 1—Depicts the finished front face view of a design (represented throughout as a dolphin).

FIG. 2—Depicts the opposite side of the finished front face piece, being the inside unfinished surface view.

FIG. 3—Depicts the finished back face view of the design.

FIG. 4—Depicts the opposite side of the finished back face piece, being the inside unfinished surface view.

FIG. 5—Depicts the inside unfinished surfaces of both the front and back pieces and the approximate locations where magnets would be attached. The number of magnets correlates with the overall size of the design. Magnets would be placed one half to one inch in from outer edges of a design. It should be noted that magnets shown are round but may vary in size, shape and composition.

FIG. 6—Depicts the front face design piece (on left) and how the magnets on the inside of the back face piece (on right), would be aligned (dotted lines) with the corresponding magnets on the inside surface of the front face piece (not shown). A strip intersects the dotted lines representing an overhead view of a screen panel and how the front and back pieces would be joined, resulting in one, two-sided cohesive design.

FIG. 7—Depicts a plastic peg containing a magnet and situated on the surface of a design.

FIG. 8—Depicts how a finished, installed design appears on a screen.

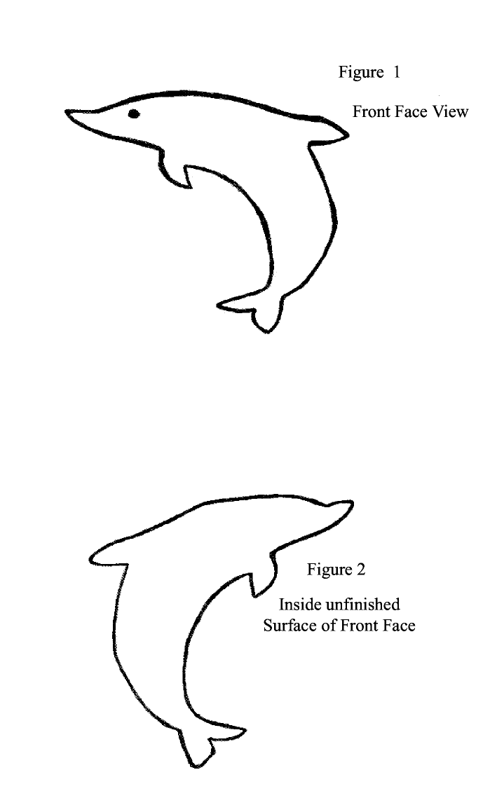

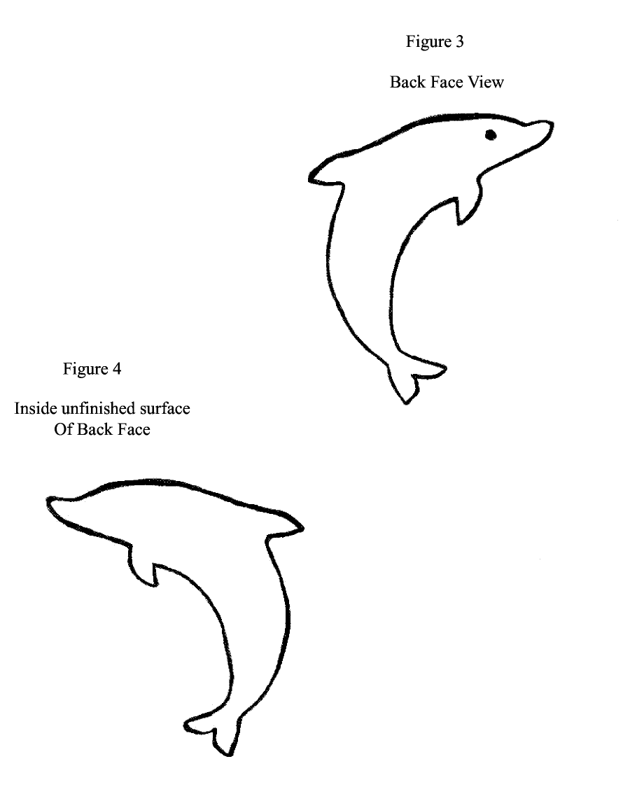

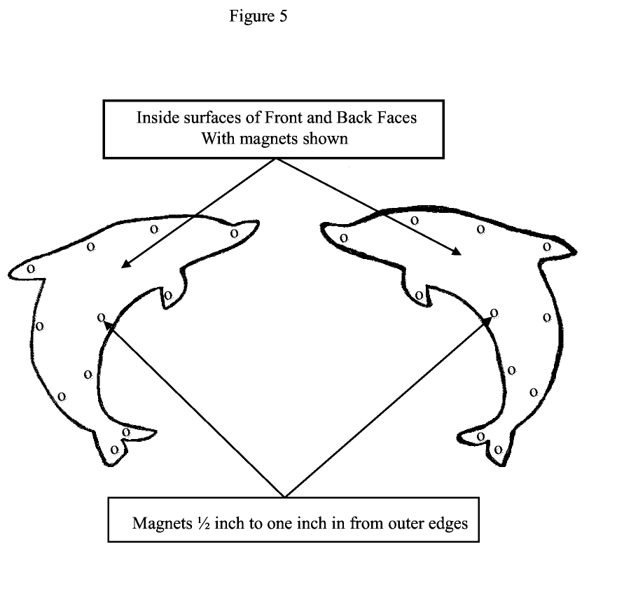

1. An outdoor mesh screen display comprising:
A decorative article comprising:
Two identical decorative foam or plastic shaped design pieces having matching decorative graphics on a finished front face (FIG. 1) and on a finished back face (FIG. 3);
Magnets affixed to the unfinished, inside surface of the front and back faces (FIG. 5) with unlike magnetic poles being mutually aligned between the front and back pieces to ensure magnetic cohesion. [Mesh screen hereinafter referred to as “screen,” and decorative foam/plastic shaped design(s) hereinafter referred to as “ornament(s)”].

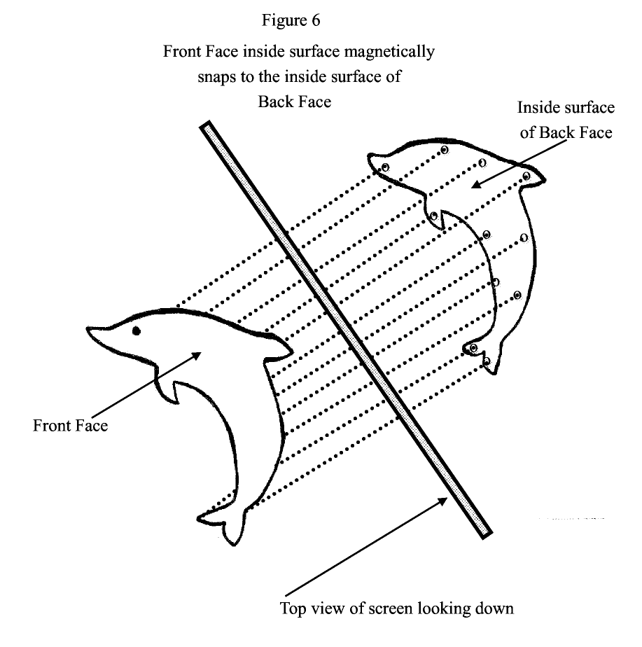

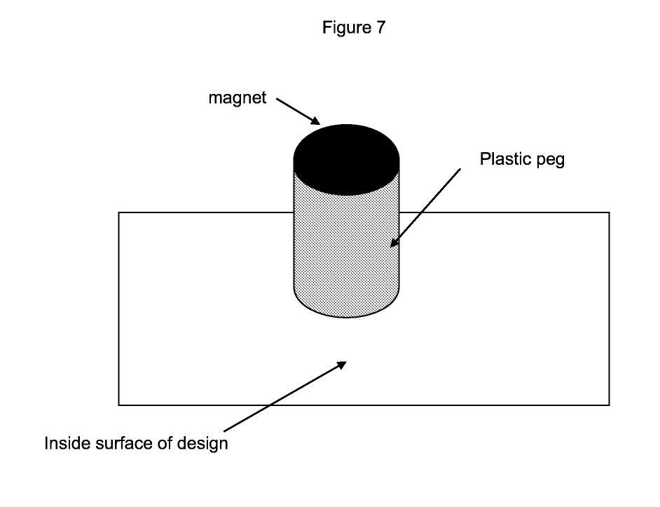

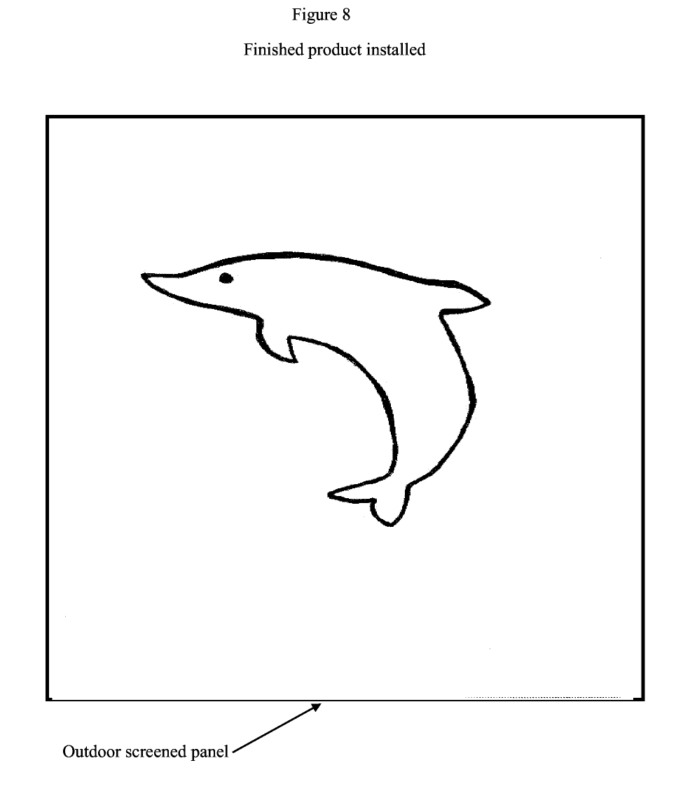

2. The two identical ornaments noted in claim 1, are installed with the screen situated in between the front and back unfinished inside surfaces of the ornament's front and back pieces (FIG. 6), and are held together by magnets that are secured to the unfinished inside surface of both front and back pieces (FIG. 5). The resultant joining of the front and back pieces of the ornament produce the appearance of a single, two-sided ornament with finished faces viewable from either side of the screen (FIG. 7).

3. Ornaments noted in claims 1 and 2, comprising:
A plurality of decorative graphics in various shapes and colors such as, but not limited to, holiday designs, nature designs, astrological designs; bird, animal, mammal, insect designs; vehicle designs, sports designs, logos, or any type of artwork or figure utilized as noted in claim 2.

4. The screen noted in claim 1 and claim 2, is exterior screening that is typically used for outside areas such as, but not limited to, screened-in swimming pool areas, and screened lanais, porches, windows, panels and doors.

5. The ornaments noted in claims 1, 2 and 3, may be single or multi-dimensional.

6. The ornaments noted in claims 1, 2, 3, and 5, are produced using industry standard foam or plastic molding techniques or may be handmade using hotwire foam-cutting tools.

7. The ornaments noted in claims 1, 2, 3, 5 and 6, may vary in overall size covering areas from between one to ten square feet.

8. Magnets noted in claims 1 and 2, are permanent magnets affixed to the inside surface of the ornament's front face piece and the back face piece (FIG. 5), and may be barrel-shaped magnets, rubber strip magnets or any type of magnet that ensures the necessary degree of magnetic attraction between the two opposing poles in order to facilitate securing the front ornament piece to the back ornament piece. Pegs may be included as part of a plastic mold for encasing magnets (FIG. 7).

9. The size and number of magnets noted in claims 1, 2, and 8, will depend on the overall size of an ornament as noted in claim 7, and will be situated between one half inch to one inch in from the outer edges of the inside unfinished surfaces of the front and back pieces of the ornament (FIG. 5).

10. Magnets as noted in claims 1, 2, 8 and 9, may be affixed to the ornaments during fabrication or may be attached afterwards using a permanent adhesive.

11. The front and back faces of the ornaments noted in claims 1 thru 9, are decorated using colors that are applied as stains, dyes, paints or glosses. A translucent top-coat may be applied for added protection from outdoor elements.
